(19) United States
(12) Patent Application Publication
(10) Pub. No.: US 2020/0307733 A1
(43) Pub. Date: Oct. 1, 2020

(54) Transport Cycle

(71) Applicant: RYTLE GmbH, Bremen (DE)

(72) Inventors: Arne Kruse, Hude (DE); Ingo Lübs, Werlte (DE)

(21) Appl. No.: 16/623,900

(22) PCT Filed: Jun. 5, 2018
(86) PCT No.: PCT/EP2018/000287

§ 371 Date: Feb. 17, 2020

(30) Foreign Application Priority Data
Jun. 19, 2017 (DE) 10 2017 005 699.4

(51) Int. Cl. B62K 7/04; B62K 5/06

(52) U.S. Cl. CPC B62K 7/04; B62K 5/06

(57) ABSTRACT

The invention relates to a transport cycle (2) comprising a frame and at least three wheels (4) of which at least two wheels (4) are designed as side wheels (6) spaced at a certain distance from one another in a direction extending transversely to a direction of travel of the transport cycle (2), wherein said transport cycle (2) has a storage area. The transport cycle (2) has two lateral supports (5) which are spaced at a certain distance from one another transversely to the direction of travel, laterally delimit, as the storage area, a storage space (10) having an access opening (11), and form therebetween the storage space (10) having an access opening (11) for inserting a transport box. The invention also relates to a transport system comprising the transport cycle and a transport box which can be inserted into the storage space.

The invention relates to a transport cycle comprising a frame and at least three wheels, wherein at least two wheels are designed as side wheels spaced at a certain distance from one another in a direction extending transversely to the direction of travel of the transport cycle, and wherein the transport cycle has a cargo area.

Such transport cycles are known on the market. The cargo area is generally arranged between the side wheels and above the hub of the side wheels and comprises a luggage rack. This may be arranged either in front of or also behind a rider area of the transport cycle. The cargo area is usually designed to receive cargo, e.g., in the form of mail or parcels in the case of postal cycles, or e.g. in the form of beverage boxes or food containers in the case of transport cycles for delivery services.

For use in a logistics system, the transport cycles known on the market usually require a manual loading of the cargo area of the cycle. This limits the possible dimensions and the possible cargo, so as to ensure manual handling of the cargo is possible. Or the flexibility is restricted, since it is only possible to use loading locations having the appropriate loading facilities on hand.

The problem which the present invention proposes to solve is first of all to provide a transport cycle for an efficient logistics system, which operated in a simple, user-friendly, and ergonomic manner and which can be used in particular with larger and/or heavier cargo than the transport cycles presently known on the market.

The present problem is solved by a transport cycle of the aforementioned kind, wherein the transport cycle has two lateral supports which are spaced at a certain distance from one another transversely to the direction of travel, bounding a cargo space, as the cargo area, with an access opening, and forming between them the cargo space with the access opening for placing a transport box therein. The access opening enables an easy placement of a transport box in the cargo space. This may be done by a movement of the transport box or by a movement of the transport cycle. The placing of cargo already assembled in a transport box in the cargo space of the transport cycle is considerably easier. This improves the ergonomics of such a transport cycle and enables an easy stowing of large and/or bulky cargo in the cargo space.

Preferably the transport cycle comprises a lifting device, by which a transport box can be lifted from a waiting position to a transport position. In the transport position the transport box is arranged in the cargo space of the transport cycle. Due to the lifting device on the transport cycle, even bulky and/or heavy transport boxes can be placed in a user-friendly and ergonomic manner in the cargo space of the transport cycle in a raised transport position. Especially preferably, the transport cycle is designed so that it can move up to a transport box in a waiting position, in which it has been set down on the floor for example, in such a way that the transport cycle receives the box through the access opening in its cargo space. The side wheels in this case are preferably moved past the transport box on opposite sides thereof.

The cargo space of the transport cycle extends as far as the ground. Thus, the cargo space bounded on the sides by the lateral supports forms a kind of garage for a transport box on the transport cycle. Because the cargo space has an access opening, the transport box standing on the ground can be placed in the cargo space, either by driving the transport cycle up to the transport box, or by pushing or pulling a transport box, mounted on rollers, through the access opening into the cargo space. Once driven into the garage, i.e., placed in the cargo space, the transport box can be raised from the ground by the lifting device of the transport cycle and be lifted into a transport position. The transport cycle carries the transport box piggyback in the cargo space. The cargo space with the access opening is thus clear of elements disturbing the placing of the transport box into the cargo space.

Preferably, the lifting device comprises a receiving element which can move in a direction perpendicular to the standing plane of the transport cycle. The receiving element can thus be brought into contact with a transport box being received. The forces lifting the transport box are thus transmitted across the receiving element of the lifting device to the transport box being received. This enables a simple design of the transport cycle comprising such a lifting device.

Especially preferably, the lifting device is mechanically and/or electrically powered. Due to a mechanical drive, a user can easily and ergonomically lift even bulky and especially heavy transport boxes into a transport position in the cargo space given a suitable gear ratio (reduction) within the drive of the lifting device. An electric drive, which can be supplied with electricity via an electric energy accumulator arranged on the transport cycle, such as a storage battery, enables a raising of the transport box entirely without effort on the part of the user. Thus, the ease of use of the transport cycle becomes even more simple and ergonomical.

Preferably the transport cycle comprises at least one fixation device comprising a fixation element which is movable into the cargo space. The fixation element is designed such that a transport box placed in the cargo space through the access opening can be secured in the transport position. In this way, the load on the lifting device can be reduced. Thus, the loads on the lifting device, and especially on the drive of the lifting device, are reduced when it does not need to hold the transport box in a raised transport position. For this, the fixation element can be movable in particular into the cargo space. The fixation element can be brought into engagement with corresponding elements of the transport box, by which the transport box can be secured in the transport position on the transport cycle. In the most simple variant, the fixation element reaches underneath a transport box placed in the cargo space in the transport position. Thus, a lowering of the transport box from the transport position is prevented and the load on the lifting device is reduced.

The fixation elements are movably arranged, so that they can be moved out from the cargo space through the access opening for the placing of a transport box in the cargo space. The access opening may thus be kept clear of disruptive elements for the smooth placing of a transport box therein.

Especially preferably, fixing assembly comprises an activating lever for moving the fixation element. The activating lever can be arranged in an easily accessible place on the transport cycle, so that an easy and ergonomical moving of the fixation element by the user of the transport cycle is possible. Especially preferably, the activating lever is designed as a treadle. In this case, after the user has lifted a transport box to be placed with the lifting device, the user can place the fixation element in the cargo space by operating the treadle of the fixation device and secure the transport box in the transport position. This enhances the easy use and the ergonomics of a corresponding transport cycle.

Preferably the transport cycle comprises an electric propulsion device, by which the propulsion of the cycle can be at least assisted. Such a propulsion device comprises at least one electric motor and an accumulator of electric energy, especially a storage battery, as well as control electronics. Such a propulsion device assists the rider of a transport cycle in the moving of the transport cycle. This is especially advantageous when heavy transport boxes need to be transported with the transport cycle. By providing such an electric propulsion device, the ergonomics and ease of use of the transport cycle are enhanced. Especially preferably, the propulsion device is designed in such a way that the transport cycle is designed as a pedelec. In this case, the propulsion device provides an additional electric propulsion power in dependence on the force applied by the rider to the pedals of the transport cycle. Such a cycle is basically thus operated not independently of human muscular effort. By the combination of electric and human muscular drive for the propulsion, the range of such a transport cycle can be increased or the size of the electric energy accumulator can be optimized for a given range. Furthermore, the assisting of the rider can be reduced or halted entirely upon reaching a certain speed of the transport cycle. In this way, the maximum attainable speed with the assist is limited and the safety of the transport cycle is enhanced.

Preferably the electric propulsion device forms a starting assist. The propulsion device provides electric power to accelerate the transport cycle from standstill, even without the rider applying force to the pedals of the transport cycle. This is done until a certain minimum speed is attained. In this way, the ease of operation and the ergonomics of such a transport cycle are enhanced. The force to be applied by the rider when starting a possibly heavily loaded transport cycle is reduced.

Preferably the electric propulsion device comprises at least one wheel hub motor. This is arranged in one of the wheels of the cycle. Especially preferably, at least one side wheel on each of the sides spaced at a certain distance from one another in a direction extending transversely to the direction of travel comprises a wheel hub motor. Due to the arrangement of wheel hub motors in the side wheels spaced at a certain distance from one another transversely to the direction of travel, it can become easier for the transport cycle to negotiate turns, for example, by a suitable control. Such a control can ensure that the wheel on the outside of the turn rotates faster than the side wheel on the inside of the turn, corresponding to the length of the distance to be traveled at the outer turn radius. This further improves the action of the electric propulsion device, which in the course enhances the ergonomics and ease of use of the transport cycle.

Preferably the frame of the transport cycle has a supporting strut assembly bounding a rider area laterally on one side. This supporting strut assembly is preferably arranged on the left side of the rider, looking in the direction of travel, in the case of righthand traffic, and on the right side of the rider in the case of lefthand traffic. The supporting strut assembly confers the necessary stability to the frame in the region of the rider area. Due to such an assembly, it can be ensured that the rider generally gets off from the transport cycle toward the pedestrian pavement. Thus, the rider of the transport cycle is protected against inadvertently getting off in the direction of oncoming traffic. Hence, the supporting strut assembly forms a kind of protection of the rider against oncoming traffic. The ergonomics and safety of the transport cycle are thus enhanced. Especially preferably, such a supporting strut assembly, bounding the rider area at the side, enables the omission of further supporting struts in the rider area which might hinder the rider in getting on and getting off the transport cycle. This allows an especially easy mounting and dismounting.

However, the supporting strut assembly at least makes it possible to arrange only one bottom tube within the rider area in the region of the bottom bracket, so that a passageway in the region of the height of a bottom bracket of the transport cycle is made possible. Thus, the mounting and dismounting is made easier for the user of the transport cycle and the ergonomics of the transport cycle are enhanced.

Preferably the rider area is arranged in front of the cargo space in the direction of travel. This enables the use of large and bulky transport boxes with the corresponding transport cycle. Due to arranging the cargo space behind the rider area in the direction of travel, an open view of the traffic situation is assured for the rider. This enhances the safety of such a transport cycle.

The problem according to the invention is furthermore solved by a vehicle system, comprising an above described transport cycle as well as a transport box designed to being placed in the cargo space of the above described transport cycle.

Preferably, rollers are arranged on a bottom side of the transport box, on which the transport box can roll. Hence, the transport box can be easily placed by the user into the cargo space through the access opening of the transport cycle. The ergonomics of the corresponding transport system are enhanced. Especially preferably, at least one roller is arranged so as to be able to turn about an axis of rotation running substantially perpendicular to a bottom side of the transport box. This can simplify the maneuverability of a corresponding transport box and hence the ease of use of the transport system. Preferably, all the rollers of the transport box are arranged on the transport box so as to be able to turn about axes of rotation arranged in parallel with the first-mentioned axis of rotation.

Preferably the transport box comprises lifting device mating pieces designed to interact with the lifting device of the transport cycle. The lifting of the transport box into a transport position by the lifting device is thus made easier. The ease of use and the ergonomics of the system are enhanced.

Especially preferably, the transport box has a maximum length of 1.2 m and a maximum width of 0.8 m. A transport box whose footprint does not exceed the mentioned dimensions is also easy and ergonomic to handle by a user of the transport cycle or a user of the transport system. Furthermore, the outside dimensions of the vehicle system are limited in this way. Such a vehicle system can easily be integrated in the existing traffic infrastructure.

Further features may be found in the following description of the figures. The following described features of the exemplary embodiments may also form the subject matter of the invention even in other feature combinations than the ones shown, although in combination with the features of claim 1. In the following, equivalent elements of the invention are given consistent reference numbers, so far as this is feasible.

There are shown:

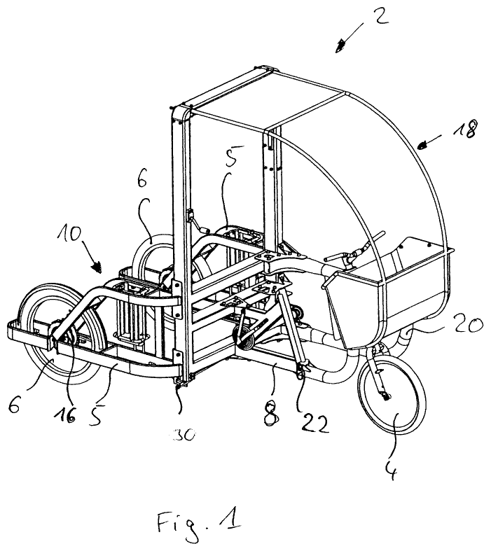

FIG. 1 an exemplary embodiment of a transport cycle according to the invention in an isometric view,

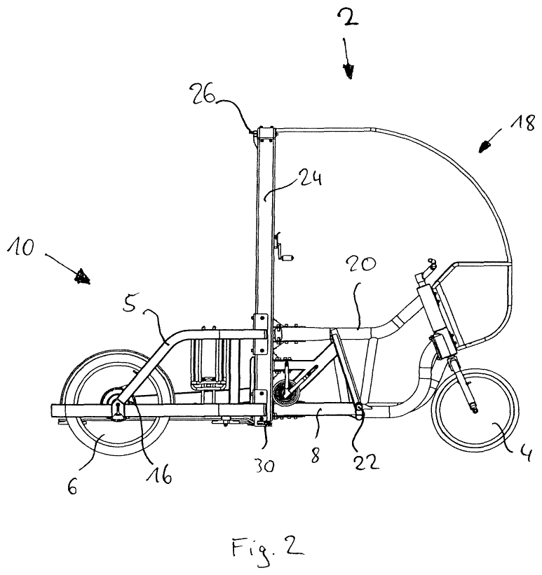

FIG. 2 the transport cycle of FIG. 1 in a side view,

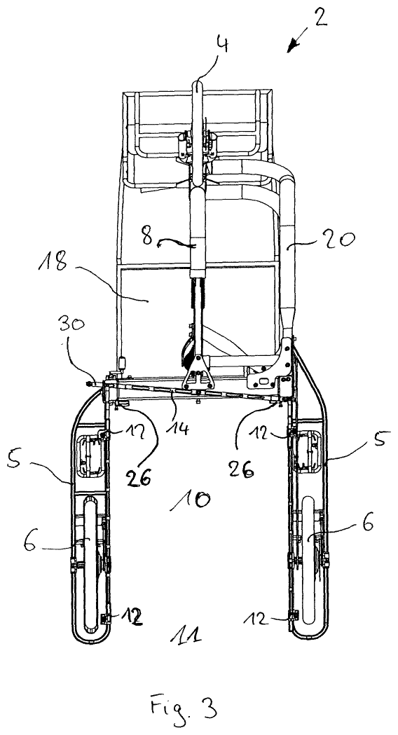

FIG. 3 the transport cycle of FIG. 1 in a view of the bottom side,

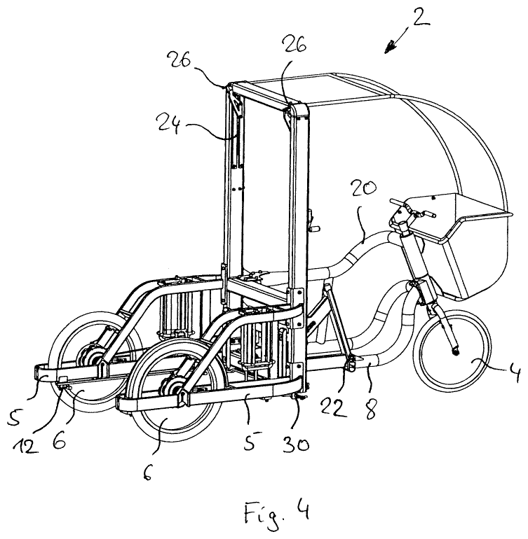

FIG. 4 the transport cycle of FIG. 1 in a view from the rear,

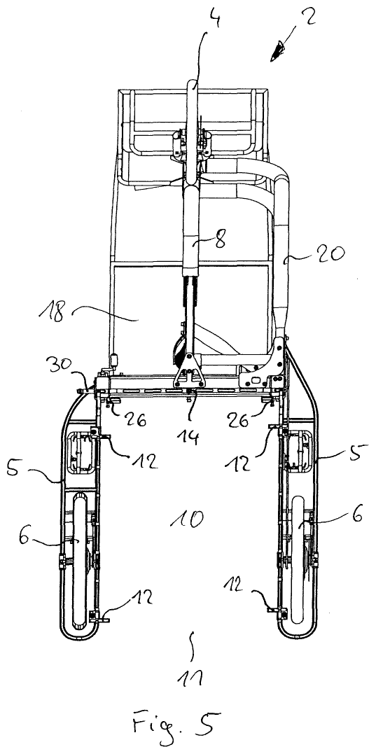

FIG. 5 a bottom view of the transport cycle of FIG. 1, fixation elements of the fixation device being introduced into the cargo space,

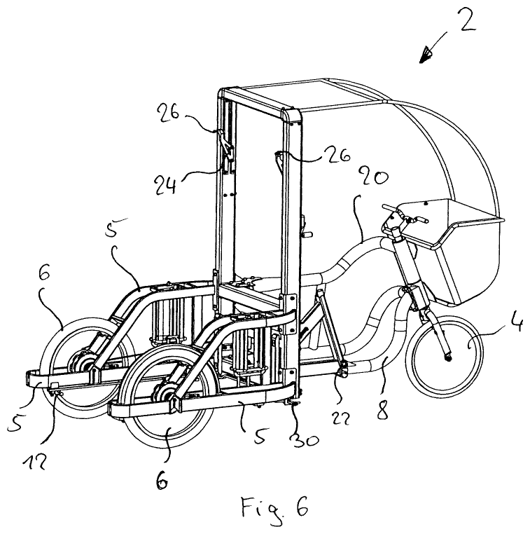

FIG. 6 an isometric view of the transport cycle of FIG. 1 with the receiving elements of the lifting device in a lowered position,

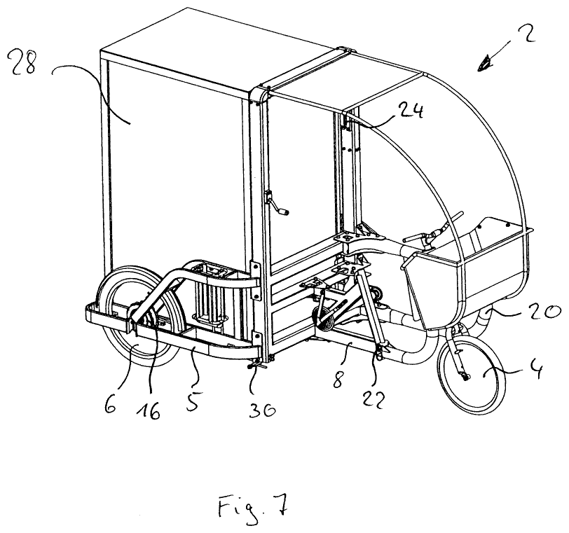

FIG. 7 an exemplary embodiment of a transport system according to the invention, consisting of a transport cycle and a transport box with the transport box received in the cargo space of the transport cycle in the transport position,

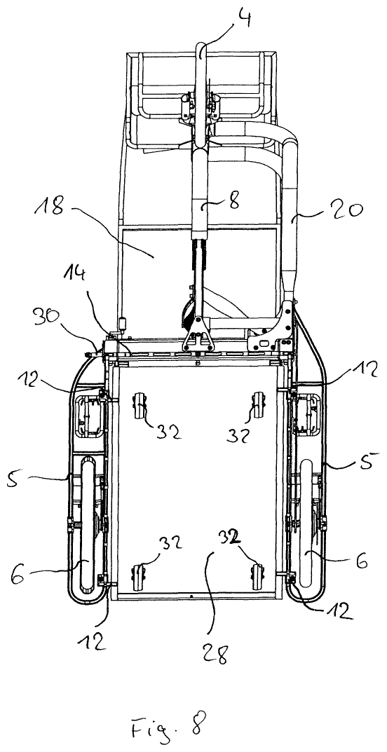

FIG. 8 the transport system of FIG. 7 in a bottom view,

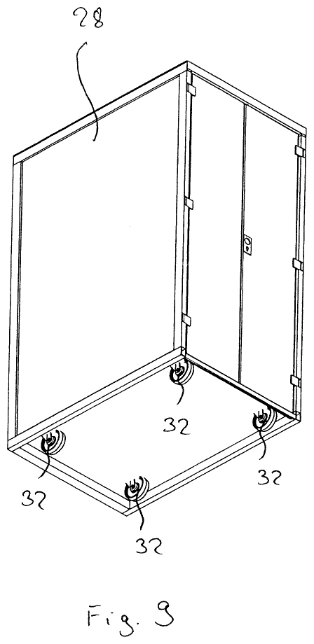

FIG. 9 the transport box.

FIG. 1 shows a transport cycle 2 with three wheels 4, two of which are fashioned as side wheels 6. Each side wheel 6 is arranged on a lateral support 5 of the transport cycle 2. A lateral support 5 is substantially a strut assembly extending backward from a frame 8 of the transport cycle 2. The two lateral supports 5 run in parallel with each other and bound a cargo space 10 comprising an access opening 11. In the present exemplary embodiment, the cargo space 10 is clear of further elements. This holds at least in the condition represented in FIG. 3, in which the fixation elements 12 of the fixation device 14 have been moved out from the cargo space. The side wheels 6 each have a wheel hub motor 16. The wheel hub motors 16 are supplied with current in each case by energy accumulators arranged on the corresponding lateral support 5 in the form of storage batteries.

FIG. 4 shows the division of the transport cycle 2 into a rider area 18 and the cargo space 10. In the present example, the rider area 18 is arranged in front of the cargo space 10 in the direction of travel. The frame 8 comprises a supporting strut assembly 20, which extends from an area behind the rider area 18 to a head tube. In the present exemplary embodiment of a transport cycle 2 intended for righthand traffic, the supporting strut assembly 20 extends on the left side of the rider area 18.

Furthermore, a bottom tube extends in the rider area 18, on which the bottom bracket 22 is arranged. Due to the use of a supporting strut assembly 20, a top tube is unnecessary. This enables an easier mounting of the rider in the rider area.

The transport cycle 2 furthermore comprises a lifting device 24. The lifting device 24 comprises a receiving element 26. In the present case, the lifting device 24 is formed by two vertically arranged profiles, in which the receiving elements 26 are movably arranged. The profiles furthermore have a cross bracing. In FIG. 2, the receiving element 26 of the lifting device 24 is represented in a position moved entirely toward the top. A transport box 28 being received in the transport cycle 2 is shown in FIG. 4. The lifting device 24 in the present exemplary embodiment is mechanically activated by a hand crank. However, it is also conceivable to provide the lifting device 24 with an electric motor for raising a transport box 28 being received.

FIG. 5 shows the fixation device 14 in a condition in which the fixation elements 12 are shown introduced into the cargo space 10. The in the present example there are four fixation elements 12, represented as being swiveled by an activating element 30, designed as a treadle, into the cargo space 10. A transport box 28 could now be set down on the fixation elements 12 in a transport position. In this way, the lifting device 24 and the receiving element 26 are relieved of the load of a transport box 28.

In the present exemplary embodiment, the rider area 18 has a canopy. Furthermore, the canopy has a transparent wind and rain protection.

FIG. 7 shows a transport system according to the invention, comprising the transport cycle 2 as well as the transport box 28, which is accommodated in the cargo space 10 of the transport cycle 2 in a transport position.

FIG. 8 shows the transport system with the transport cycle 2 and the transport box 28 in a bottom view. The fixation elements 12 of the fixation device 14 have been swiveled underneath the transport box 28, raised by the lifting device 24, and secure it. The fixation device comprises a pushrod gear, by which a movement of an activating element 30 designed as a treadle is converted into a swivel movement of the fixation elements 12.

FIG. 9 shows a transport box 28 of the transport system. On a bottom side of the transport box 28 there are arranged rollers 32. The transport box 28 can thus be easily moved on the rollers 32 even in a position detached from the transport cycle 2. The transport box 28 is designed as a closed boxlike element, which is accessible through a two-piece closable hinged door.

What is claimed is:

1-17. (canceled)

18. A transport cycle (2) comprising:
a frame (8);
two lateral supports (5) connected to the frame (8) and spaced at a distance from one another transversely to a direction of travel of the transport cycle (2);
three or more wheels (4, 6), wherein at least two of the wheels are side wheels (6) connected to the two lateral supports (5) and spaced at a distance from one another transversely to the direction of travel of the transport cycle (2);
wherein the two lateral supports (5) laterally bound and form a cargo space (10) with an access opening (11), wherein the cargo space (10) is configured to accommodate a transport box (28) therein;
a rider area (18) arranged in front of the cargo space (10) in the direction of travel.

19. The transport cycle (2) as claimed in claim 18, further comprising a lifting device (24) configured to lift a transport box (28) from a waiting position to a transport position in which the transport box (28) is arranged within the cargo space (10).

20. The transport cycle (2) as claimed in claim 19, wherein the lifting device (24) comprises a receiving element (26) configured to move in a direction perpendicular to a standing plane of the transport cycle (2).

21. The transport cycle (2) as claimed in claim 20, wherein the lifting device (24) is mechanically powered; electrically powered; or mechanically and electrically powered.

22. The transport cycle (2) as claimed in claim 18, further comprising a fixation device (14) comprising at least one fixation element (12) movable into the cargo space (10) and configured to secure a transport box (28), when placed into the cargo space (27) in a transport position on the transport cycle (2).

23. The transport cycle (2) as claimed in claim 22, wherein the fixation device (14) comprises an activating element (30) configured to act on the fixation element (12) to move the fixation element (12).

24. The transport cycle (2) as claimed in claim 23, wherein the activating element (30) is a treadle.

25. The transport cycle (2) as claimed in claim 18, further comprising an electric propulsion device configured to at least assist in propelling the transport cycle (2).

26. The transport cycle (2) as claimed in claim 25, wherein the electric propulsion device is at least a starting assist.

27. The transport cycle (2) as claimed in claim 25, wherein the electric propulsion device comprises at least one wheel hub motor (16).

28. The transport cycle (2) as claimed in claim 18, wherein the frame (8) comprises a supporting strut assembly (20) bounding the rider area (18) laterally on one side.

29. The transport cycle (2) as claimed in claim 18, wherein the frame (8) has a passageway arranged in the rider area (18) substantially at a height of a bottom bracket (22) of the transport cycle (2).

30. A vehicle system for transporting goods, the vehicle system comprising:
a transport cycle (2) as claimed in claim 18;
a transport box (28) configured to be placed into the cargo space (10) of the transport cycle (2).

31. The vehicle system as claimed in claim 30, wherein the transport box (28) comprises rollers (32) arranged on a bottom side of the transport box (28), wherein the transport box (28) can roll on the rollers (32).

32. The vehicle system as claimed in claim 31, wherein at least one of the rollers (32) is configured to turn about an axis of rotation that is substantially perpendicular to the bottom side of the transport box (28).

33. The vehicle system as claimed in claim 30, wherein the transport cycle (2) comprises a lifting device (24) configured to lift the transport box (28) from a waiting position to a transport position in which the transport box (28) is arranged within the cargo space (10), wherein the transport box (28) comprises lifting device mating pieces configured to interact with the lifting device (24) of the transport cycle (2).

34. The vehicle system as claimed in claim 30, wherein the transport box (28) has a maximum length of 1.2 m and a maximum width of 0.8 m.
